(19) United States
(12) Patent Application Publication
(10) Pub. No.: US 2024/0146510 A1
(43) Pub. Date: May 2, 2024

(54) DISTRIBUTED SWARM BASED SYSTEM FOR AUTHENTICATION KEY ENCRYPTION USING IMAGE PROCESSING

(71) Applicant: BANK OF AMERICA CORPORATION, Charlotte, NC (US)

(72) Inventor: Elvis Nyamwange, Little Elm, TX (US)

(73) Assignee: BANK OF AMERICA CORPORATION, Charlotte, NC (US)

(21) Appl. No.: 17/974,061

(22) Filed: Oct. 26, 2022

(51) Int. Cl. H04L 9/08; G06T 7/10; G06T 7/70; G06T 9/00; H04L 9/32

(52) U.S. Cl. CPC H04L 9/0819; G06T 7/10; G06T 7/70; G06T 9/00; H04L 9/32

(57) ABSTRACT

Systems, computer program products, and methods are described herein for distributed swarm based system for encryption key encryption using image processing. The present disclosure is configured to receive, from a first user input device, a user request from a first user to encrypt an encryption key; retrieve, from a key repository, the encryption key; encode the encryption key in an image; segment the image with the encryption key encoded therewithin into one or more image components; store the one or more image components in one or more end-point devices; and record information associated with the end-point devices corresponding to the encryption key in the key repository.

### TECHNOLOGICAL FIELD

Example embodiments of the present disclosure relate to distributed swarm based system for encryption key encryption using image processing.

### BACKGROUND

Proper encryption key management is critical to the security of a computing environment. Authentication key management concerns keys at the user level, either between users or systems. This includes dealing with the generation, exchange, storage, use, destruction, and replacement of keys.

Applicant has identified a number of deficiencies and problems associated with encryption key encryption and storage. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for distributed swarm based system for encryption key encryption using image processing.

In one aspect, a system for encryption key encryption using image processing is presented. The system comprising: a non-transitory storage device; and a processor coupled to the non-transitory storage device, wherein the processor is configured to: receive, from a first user input device, a user request from a first user to encrypt an encryption key; retrieve, from a key repository, the encryption key; encode the encryption key in an image; segment the image with the encryption key encoded therewithin into one or more image components; store the one or more image components in one or more end-point devices; and record information associated with the end-point devices corresponding to the encryption key in the key repository.

In some embodiments, in segmenting the image into the one or more image components, the processor is further configured to: receive, from the first user input device, a number of image segments; and segment the image into the one or more image components based on at least the number of image segments; and record the number of image segments corresponding to the encryption key in the key repository.

In some embodiments, in segmenting the image into the one or more image components, the processor is further configured to: determine one or more pixel coordinates associated with the one or more image components; and store the one or more pixel coordinates corresponding to the one or more image components in the key repository.

In some embodiments, in encoding the encryption key in the image, the processor is further configured to: receive, from the first user input device, an object; determine, using object detection, one or more instances of the object in the image; and encode the encryption key in the one or more instances of the object.

In some embodiments, the processor is further configured to: receive, from a second user input device, a request from a second user to extract the encryption key; determine an authentication level of second user; determine whether the authentication level of the second user matches an authentication requirement associated with extraction of the encryption key; and extract the encryption key in an instance where the authentication level of the second user matches the authentication requirement associated with the extraction of the encryption key.

In some embodiments, in extracting the encryption key, the processor is further configured to: retrieve, from the key repository, the information associated with the one or more end-point devices; retrieve, the one or more image components from the one or more end-point devices; and assemble the image using the one or more image components.

In some embodiments, the processor is further configured to: decode the encryption key from the assembled image; and transmit the encryption key to the second user.

In another aspect, a computer program product for encryption key encryption using image processing is presented. The computer program product comprising a non-transitory computer-readable medium comprising code causing an apparatus to: receive, from a first user input device, a user request from a first user to encrypt an encryption key; retrieve, from a key repository, the encryption key; encode the encryption key in an image; segment the image with the encryption key encoded therewithin into one or more image components; store the one or more image components in one or more end-point devices; and record information associated with the end-point devices corresponding to the encryption key in the key repository.

In yet another aspect, method for encryption key encryption using image processing is presented. The method comprising: receiving, from a first user input device, a user request from a first user to encrypt an encryption key; retrieving, from a key repository, the encryption key; encoding the encryption key in an image; segmenting the image with the encryption key encoded therewithin into one or more image components; storing the one or more image components in one or more end-point devices; and recording information associated with the end-point devices corresponding to the encryption key in the key repository.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for distributed swarm based system for encryption key encryption using image processing, in accordance with an embodiment of the disclosure.

FIG. 2 illustrates a process flow for encoding the encryption key in an image using image processing techniques, in accordance with an embodiment of the disclosure.

FIG. 3 illustrates a process flow for decoding the encryption key from the image using image processing techniques, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

The present disclosure is in the field of encryption key management. Embodiments of the present disclosure solves a problem in the field of encryption key management using steganographic image processing means. The encryption key (e.g., public key, private key, or the like) are encoded within an image using steganography. The encoded image is then segmented into multiple image components, and stored in multiple end-point devices across the computing environment. In this way, even if an unauthorized person manages to gain access to an end-point device, they will only be able to access one or a subset of image components, which may have little to no meaning to them if their goal is to misappropriate the encryption key. When an authorized user wishes to access the encryption key, the image is re-assembled using image components and the encryption key is decoded from the assembled image.

In other words, the present disclosure, (i) Receives, from a first user input device, a user request from a first user to encrypt an encryption key. The encryption key may refer to any random string of alphanumeric values used in authentication, encryption, or any form of computational security, (ii) Retrieves, from a key repository, the encryption key, (iii) Encodes the encryption key in an image. Encodes the encryption key in specific objects within the image. Records the specific objects selected by the user along with the encryption key in the key repository. Segments the image with the encryption key encoded therewithin into one or more image components. Receives, from a user input device, a specific number of image segments that the user (e.g., first user) wishes to segment the image. Records the specific number of image segments along with the encryption key in the key repository. Records pixel coordinate information for each image component. Records the pixel coordinates for each image component along with the encryption key in the key repository, (iv) Stores the one or more image components in one or more end-point devices, (v) Records information associated with the end-point devices corresponding to the encryption key in the key repository, (vi) Receives, from a second user input device, a request from a second user to extract the encryption key, (vii) Determines an authentication level of second user. Determines whether the authentication level of the second user matches an authentication requirement associated with extraction of the encryption key, and (viii) Extracts the encryption key in an instance where the authentication level of the second user matches the authentication requirement associated with the extraction of the encryption key. Retrieves from the key repository, metadata or peripheral information associated with the encoding of the encryption key in the image, such as the information associated with the end-point devices storing the image components, the number of image segments corresponding to the encryption key, the pixel coordinates corresponding to the image segments, specific objects in which the encryption key is encoded, and/or the like. Assembles the image using the image components based on the metadata or peripheral information. Decodes the encryption key from the assembled image and transmit the encryption key to the user.

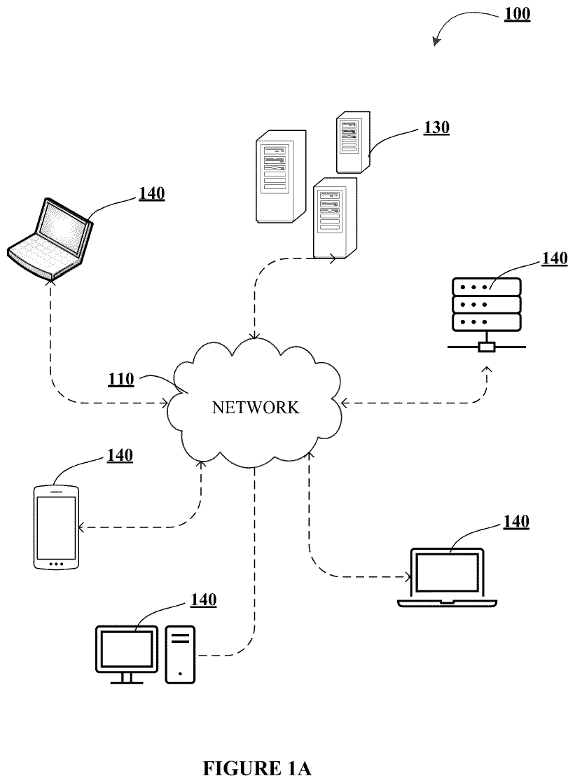

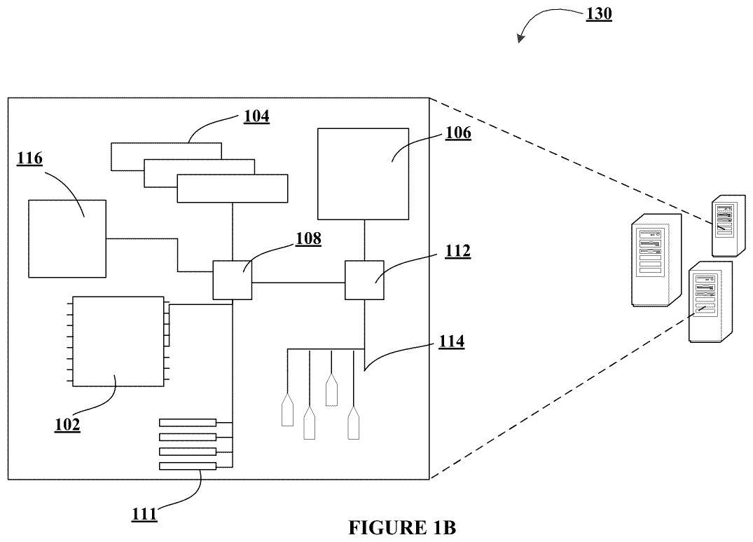

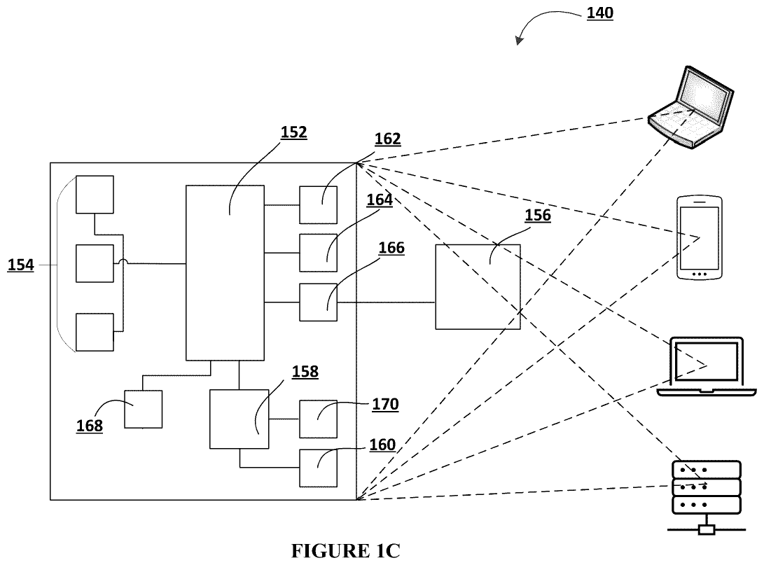

FIGS. 1A-1C illustrate technical components of an exemplary distributed computing environment for distributed swarm based system for encryption key encryption using image processing 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

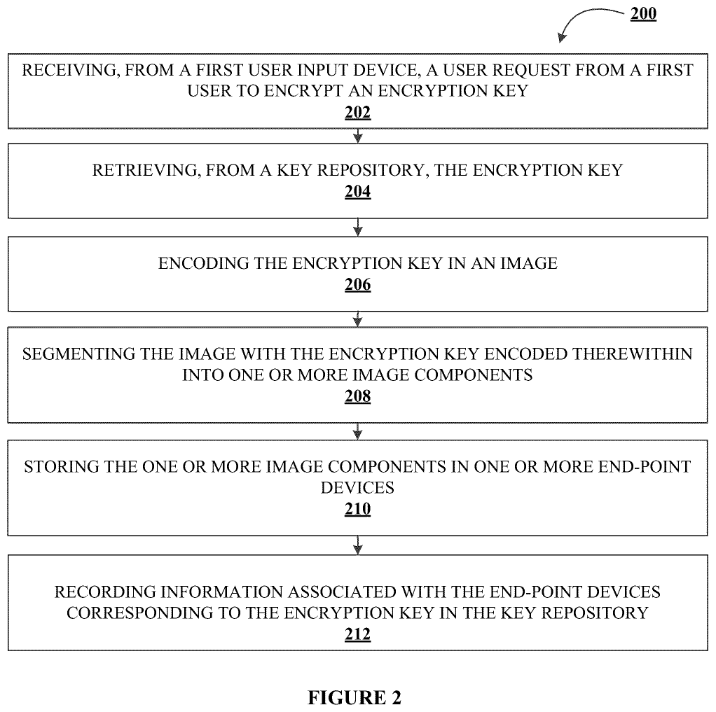

FIG. 2 illustrates a process flow for encoding the encryption key in an image using image processing techniques, in accordance with an embodiment of the disclosure. As shown in block 202, the process flow includes receiving, from a first user input device, a user request from a first user to encrypt an encryption key. An encryption key may refer to a variable value that is applied using an algorithm to a string or block of unencrypted resource to produce an encrypted resource or to decrypt an encrypted resource. The encryption key may be a public encryption key, a private encryption key, or a public-private encryption key pair depending on the type of encryption process involved, such as symmetric encryption, asymmetric encryption, and/or the like. In some embodiments, the encryption key may refer to any random string of alphanumeric values used in authentication, encryption, or any form of computational security.

Next, as shown in block 204, the process flow includes retrieving, from a key repository, the encryption key. In some embodiments, a key repository may refer to any location associated with the computing environment, local, cloud, or otherwise, where encryption keys are stored. In response to receiving the request from the user (e.g., first user), the system may establish a communication link with the appropriate key repository to retrieve the encryption key.

Next, as shown in block 206, the process flow includes encoding the encryption key in an image. In some embodiments, the image may be an RGB color image, such as 24-bit RGB color images. Such images offer great embedding capacity because they include an array of pixels where each pixel has three components: a red component, a green component, and a blue component. Typically, the intensity of each color component is stored as a numerical channel value using 8 bits, A 24-bit RGB color image also is useful because each pixel is independent of all other pixels in the RGB color image. However, it should be understood that the image may include other suitable carrier objects for embedding the encryption key.

In some embodiments, the system may encode the encryption key in specific objects within the image. For example, the user (e.g., first user) may wish to steganographically encode the encryption key within each instance of a cat in the image. In such cases, the system may implement image object recognition/detection techniques to detect various instances of the object (e.g., cat) within the image. In one aspect, object detection allows for determination of where the objects are located in the image (object localization) and what the object is (object classification). To achieve this, any suitable object recognition/detection algorithm may be used. Examples of object detection algorithms may include Region based Convolutional Neural Network (R-CNN), Region based Fully Convolutional Neural Network (R-FCN), Fast R-CNN, Faster R-CNN, Histogram of Oriented Gradients (HOG), Single Shot Detector (SSD), Spatial Pyramid Pooling (SPP-net), You Only Look Once (YOLO), and/or the like. In response to identifying the various instances of the object, the system may encode the encryption key in the various instances of the object. For example, when encoding the encryption key within the image, the system may encode the encryption key only in objects recognized to represent cats.

Next, as shown in block 208, the process flow includes segmenting the image with the encryption key encoded therewithin into one or more image components. Image segmentation may refer to the process of partitioning an image (e.g., a digital image) into multiple image components, also known as image components, image regions, or image structures (sets of pixels). In some embodiments, the system may segment the image into a specific number of image segments based on a user input. To this end, the system may receive, from a user input device, a specific number of image segments that the user (e.g., first user) wishes to segment the image. In response, the system may segment the image into various image components based on the number of image segments requested by the user. In response to segmenting the image, the system may record the specific number of image segments along with the encryption key in the key repository.

In some embodiments, the system may record pixel coordinate information for each image component. The location of a pixel or an array element in the image is uniquely defined by its pixel coordinates. These coordinates may be specified in the form of a linear offset—a sequential number ranging from 1 to the total number of pixels in each image, as axis coordinates — pixel location as an array in multi-dimensional space, or any other suitable coordinate forms. Therefore, when segmenting the image into various components, the system may determine pixel coordinates for each image component. In response, the system may record the pixel coordinates for each image component along with the encryption key in the key repository.

Next, as shown in block 210, the process flow includes storing the one or more image components in one or more end-point devices. In some embodiments, the end-point devices may be identified by the user (e.g., first user) when requesting that the encryption key be encrypted. In some other embodiments, the end-point devices may be assigned at random by the system after the image has been segmented into various image components. In one aspect, each image component is stored in a different end-point device. In another aspect, a set of image components may be stored in each end-point device. In some embodiments, each image component may be subject to a unique authentication requirement. To this end, when storing the image component in an end-point device, the system may establish an authentication requirement for the image component, such that any request to access the image component must include an authentication level that meets the authentication requirement for the image component.

Next, as shown in block 212, the process flow includes recording information associated with the end-point devices corresponding to the encryption key in the key repository. To this end, the system may record a number of end-point devices used to store the image components, number of image components stored in each end-point device, a unique identifier associated with each end-point device, and/or the like.

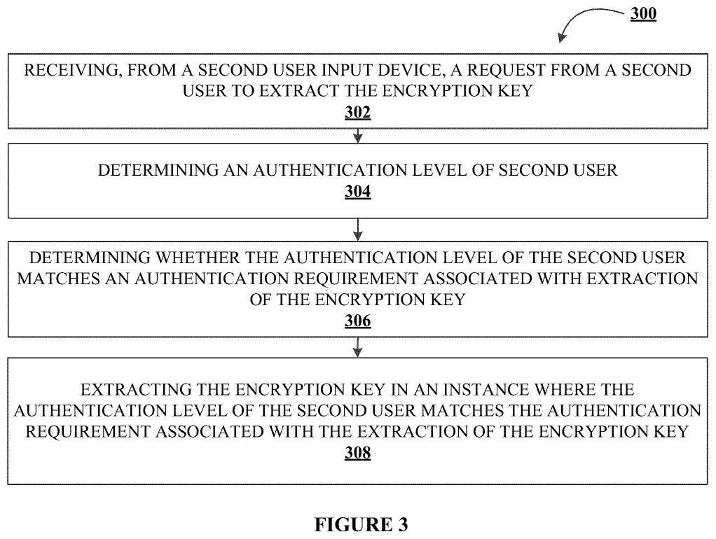

FIG. 3 illustrates a process flow for decoding the encryption key from the image using image processing techniques, in accordance with an embodiment of the disclosure. As shown in block 302, the process flow includes receiving, from a second user input device, a request from a second user to extract the encryption key. In some embodiments, the user (e.g., second user) may wish to access a resource that is encrypted using the encryption key. When the user requests access to the resource, the system may automatically generate a request to extract the encryption key. In some other embodiments, the user may have to procure the encryption key prior to being able to request access to the resource.

Next, as shown in block 304, the process flow includes determining an authentication level of second user. In some embodiments, the authentication level of the user determines specific resources the user has access to. Said differently, authentication level may refer to fine-grained level of restrictions and permissions assigned to a user for access to resources within a computing environment. In one aspect, the authentication level of the user may be determined based on the authentication credentials provided by the user. In this regard, the authentication level of the user may be determined based on the type of authentication credentials provided, the number of authentication credentials provided, the combination of authentication credentials provided, and/or the like.

Next, as shown in block 306, the process flow includes determining whether the authentication level of the second user matches an authentication requirement associated with extraction of the encryption key. Access to any managed resource typically requires the accessor to provide proof of authorization in the form of proper credentials that meets the level of security required to access the resource. Similar authentication requirements may also exist for extraction of encryption keys. Therefore, any authentication credential presented by the user (which determines the user's authentication level) must meet the authentication requirement associated with the encryption key for the user to initiate the extraction process.

Next, as shown in block 308, the process flow includes extracting the encryption key in an instance where the authentication level of the second user matches the authentication requirement associated with the extraction of the encryption key. In some embodiments, to extract the encryption key, the system may first be the process of assembling the image components to re-form the image with the encryption key encoded therewithin. To this end, the system may retrieve from the key repository, metadata or peripheral information associated with the encoding of the encryption key in the image, such as the information associated with the end-point devices storing the image components, the number of image segments corresponding to the encryption key, the pixel coordinates corresponding to the image segments, specific objects in which the encryption key is encoded, and/or the like. Then, the system may retrieve the image components from the end-point devices and assemble the image using the image components based on the metadata or peripheral information. Once the image is assembled, the system may then decode the encryption key from the assembled image and transmit the encryption key to the user.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for encryption key encryption using image processing, the system comprising:
a non-transitory storage device; and
a processor coupled to the non-transitory storage device, wherein the processor is configured to:
receive, from a first user input device, a user request from a first user to encrypt an encryption key;
retrieve, from a key repository, the encryption key;
encode the encryption key in an image;
segment the image with the encryption key encoded therewithin into one or more image components;
store the one or more image components in one or more end-point devices; and
record information associated with the end-point devices corresponding to the encryption key in the key repository.

2. The system of claim 1, wherein, in segmenting the image into the one or more image components, the processor is further configured to:
receive, from the first user input device, a number of image segments; and
segment the image into the one or more image components based on at least the number of image segments; and
record the number of image segments corresponding to the encryption key in the key repository.

3. The system of claim 1, wherein, in segmenting the image into the one or more image components, the processor is further configured to:
determine one or more pixel coordinates associated with the one or more image components; and
store the one or more pixel coordinates corresponding to the one or more image components in the key repository.

4. The system of claim 1, wherein, in encoding the encryption key in the image, the processor is further configured to:
receive, from the first user input device, an object;
determine, using object detection, one or more instances of the object in the image; and
encode the encryption key in the one or more instances of the object.

5. The system of claim 1, wherein the processor is further configured to:
receive, from a second user input device, a request from a second user to extract the encryption key;
determine an authentication level of second user;
determine whether the authentication level of the second user matches an authentication requirement associated with extraction of the encryption key; and
extract the encryption key in an instance where the authentication level of the second user matches the authentication requirement associated with the extraction of the encryption key.

6. The system of claim 5, wherein, in extracting the encryption key, the processor is further configured to:
retrieve, from the key repository, the information associated with the one or more end-point devices;
retrieve, the one or more image components from the one or more end-point devices; and
assemble the image using the one or more image components.

7. The system of claim 6, wherein the processor is further configured to:
decode the encryption key from the assembled image; and
transmit the encryption key to the second user.

8. A computer program product for encryption key encryption using image processing, the computer program product comprising a non-transitory computer-readable medium comprising code causing an apparatus to:
receive, from a first user input device, a user request from a first user to encrypt an encryption key;
retrieve, from a key repository, the encryption key;
encode the encryption key in an image;
segment the image with the encryption key encoded therewithin into one or more image components;
store the one or more image components in one or more end-point devices; and
record information associated with the end-point devices corresponding to the encryption key in the key repository.

9. The computer program product of claim 8, wherein, in segmenting the image into the one or more image components, the apparatus is further configured to:
receive, from the first user input device, a number of image segments; and
segment the image into the one or more image components based on at least the number of image segments; and
record the number of image segments corresponding to the encryption key in the key repository.

10. The computer program product of claim 8, wherein, in segmenting the image into the one or more image components, the apparatus is further configured to:
determine one or more pixel coordinates associated with the one or more image components; and
store the one or more pixel coordinates corresponding to the one or more image components in the key repository.

11. The computer program product of claim 8, wherein, in encoding the encryption key in the image, the apparatus is further configured to:
receive, from the first user input device, an object;
determine, using object detection, one or more instances of the object in the image; and
encode the encryption key in the one or more instances of the object.

12. The computer program product of claim 8, wherein the apparatus is further configured to:
receive, from a second user input device, a request from a second user to extract the encryption key;
determine an authentication level of second user;
determine whether the authentication level of the second user matches an authentication requirement associated with extraction of the encryption key; and
extract the encryption key in an instance where the authentication level of the second user matches the authentication requirement associated with the extraction of the encryption key.

13. The computer program product of claim 12, wherein, in extracting the encryption key, the apparatus is further configured to:
retrieve, from the key repository, the information associated with the one or more end-point devices;
retrieve, the one or more image components from the one or more end-point devices; and
assemble the image using the one or more image components.

14. The computer program product of claim 13, wherein the apparatus is further configured to:
decode the encryption key from the assembled image; and
transmit the encryption key to the second user.

15. A method for encryption key encryption using image processing, the method comprising:
receiving, from a first user input device, a user request from a first user to encrypt an encryption key;
retrieving, from a key repository, the encryption key;
encoding the encryption key in an image;
segmenting the image with the encryption key encoded therewithin into one or more image components;
storing the one or more image components in one or more end-point devices; and
recording information associated with the end-point devices corresponding to the encryption key in the key repository.

16. The method of claim 15, wherein the method further comprises:
receiving, from the first user input device, a number of image segments; and
segmenting the image into the one or more image components based on at least the number of image segments; and
recording the number of image segments corresponding to the encryption key in the key repository.

17. The method of claim 15, wherein the method further comprises:
determining one or more pixel coordinates associated with the one or more image components; and
storing the one or more pixel coordinates corresponding to the one or more image components in the key repository.

18. The method of claim 15, wherein the method further comprises:
receiving, from the first user input device, an object;
determining, using object detection, one or more instances of the object in the image; and
encoding the encryption key in the one or more instances of the object.

19. The method of claim 15, wherein the method further comprises:
receiving, from a second user input device, a request from a second user to extract the encryption key;
determining an authentication level of second user;
determining whether the authentication level of the second user matches an authentication requirement associated with extraction of the encryption key; and
extracting the encryption key in an instance where the authentication level of the second user matches the authentication requirement associated with the extraction of the encryption key.

20. The method of claim 19, wherein the method further comprises:
retrieving, from the key repository, the information associated with the one or more end-point devices;
retrieving, the one or more image components from the one or more end-point devices; and
assembling the image using the one or more image components.
